(19) United States
(12) Patent Application Publication
(10) Pub. No.: US 2020/0245788 A1
(43) Pub. Date: Aug. 6, 2020

(54) FOOD SHIELD WITH EXTENDED SPAN

(71) Applicant: Brass Smith Innovations, LLC (BSI Designs), Wilmington, DE (US)

(72) Inventors: Geoffrey R. Quinter, Denver, CO (US); Wayne Sirmons, Denver, CO (US)

(21) Appl. No.: 16/781,750

(22) Filed: Feb. 4, 2020

Related U.S. Application Data
(60) Provisional application No. 62/801,714, filed on Feb. 6, 2019.

(51) Int. Cl. A47F 10/06; F16B 5/06

(52) U.S. Cl. CPC A47F 10/06; A47F 2010/065; F16B 5/0685

(57) ABSTRACT

An extended span food shield system including a central beam having at least one hooking surface. The central beam is supported at opposing ends by two support legs. The food shield system further includes at least one clip having at least one hook element and a panel bonded to the clip such that the panel and clip assembly are supported by the central beam when the hook element is engaged with the central beam at the hooking surface. The clip may include a leg extending away from the hook element. Therefore, the leg rests against the central beam when the hook element of the clip is engaged with the central beam at the hooking surface. Thus, the panel and clip assembly may be securely supported by the central beam and held in place by gravitationally applied torque alone.

### RELATED APPLICATIONS

This application claims priority to U.S. Patent Application Ser. No. 62/801,714 (the '714 application), filed on Feb. 6, 2019 by Geoffrey R. Quinter (attorney docket no. 0702.08PR), entitled, “FOOD SHIELD WITH EXTENDED SPAN”, the entire teachings of which are incorporated herein by reference in its entirety for all purposes.

### FIELD OF THE INVENTION

The present disclosure relates to systems, apparatus and methods for implementing a food shield, and more particularly to systems, apparatus and methods for implementing a food shield with an extended span.

### BACKGROUND OF THE INVENTION

Food shields, also sometimes called sneeze guards, are used in a variety of settings. Typically, a food shield includes at least one customer-facing transparent panel that is suspended over a buffet, smorgasbord, salad bar, retail display, or other kind of food display. Often, a food shield system will include transparent top and transparent end panels as well. The customer-facing and top transparent panels can be supported at or near the panel ends by brackets attached to a frame, stand or other structure. The food shield panels are therefore self-supporting between the brackets attached to each end. Since the food shield panels are self-supporting between the ends, the length of these panels is limited by the mechanical properties of the material used to fabricate the panels. Glass, plastic, transparent acrylic, polycarbonate, or other food shield panel materials for example, will bend under the weight of the panel when supported at the ends. The amount of bending may not be noticeable and typically does not affect the structural integrity of a food shield system if the food shield panels are fabricated to a reasonable thickness and maintained at a suitable length, for example less than four feet or less than six feet.

Glass, plastic, transparent acrylic, polycarbonate or other suitable customer-facing panels or top panels fabricated to an extended length will bend noticeably if not supported between the ends and are subject to enhanced risk of breakage. The embodiments disclosed herein are directed toward overcoming one or more of the above problems.

### SUMMARY

Various embodiments disclosed herein provide apparatus and methods for implementing a food shield. Certain disclosed embodiments provide apparatus for implementing a food shield with an extended span. One representative example of extended span food shield system includes a central beam comprising at least one hooking surface. The central beam is supported at opposing ends by two support legs. The food shield system further includes at least one clip having at least one hook element and a panel bonded to the clip such that the panel and clip assembly are supported by the central beam when the hook element is engaged with the central beam at the hooking surface.

The clip may include a leg extending away from the hook element. In such an embodiment, the leg rests against the central beam when the hook element of the clip is engaged with the central beam at the hooking surface. Thus, the panel and clip assembly may be securely supported by the central beam and held in place by gravitationally applied torque alone.

The food shield system may include forward or customer-facing panels and upward facing top panels. In some of the disclosed embodiments both types of panels may be supported by the central beam. For example, the central beam may include a front hooking surface on one side of the central beam and a rear hooking surface on another side of the central beam. A front clip having a front clip hook may be bonded to a customer-facing panel such that the front clip/customer—facing panel assembly may be fully supported by the central beam at the front hooking surface. Simultaneously, a top panel may be bonded to a rear clip having a rear clip hook element such that the top panel/rear clip assembly may be supported by the central beam at the rear hooking surface. Each of the front clip and rear clip may be provided with legs that rest against the central beam when each hook is engaged with the central beam at a hooking surface.

The angular orientation of a top or customer-facing panel may be selectively determined by the angle between the clip bonding surface and the clip leg, plus the cross-section profile of the central beam. For example, the front clip leg may define a right angle with the front clip bonding surface to support the customer-facing panel in a plane angled downward from the central beam, when mounted to a central beam having a triangular profile. Similarly, the rear clip leg may define an obtuse angle with the rear clip bonding surface to support the top panel in a horizontal plane, when engaged with a central beam having a triangular profile.

System embodiments may include any number of customer-facing panels or top panels bonded to separate clips with multiple panel and clip assemblies being supported by the central beam between two support legs. Thus, in system embodiments rigidity along an extended span is primarily provided by the central beam which may be engineered to have an extremely rigid profile. Thus, the disclosed embodiments can effectively span a greater distance between two support legs that might be possible where various panels extend without additional support between support legs or brackets attached to the support legs.

System embodiments may include one or more accessory brackets. The accessory brackets may include an accessory bracket hook for engagement with a hooking surface of the central beam. An accessory bracket may also include an accessory bracket leg which rests against the central beam when the accessory bracket hook is engaged with the central beam at the rear hooking surface. One or more accessory brackets may support a food shield system accessory of any type, including but not limited to heat lamps, spotlighting and the like.

In one embodiment, each of the support legs includes a base, a riser extending upward from the base, and a top connection having a socket configured to receive and support one end of the central beam. The socket may have one or more protrusions shaped to engage with openings formed in the opposing ends of the central beam.

Alternative embodiments include individual central beam and clip assemblies as described herein or methods of providing and supporting a food shield panel having an extended span between two legs.

Various modifications and additions can be made to the embodiments discussed without departing from the scope of the invention. For example, while the embodiments described above refer to particular features, the scope of this invention also includes embodiments having different combination of features and embodiments that do not include all of the above described features.

### BRIEF DESCRIPTION OF THE DRAWINGS

FIG. 1 is a perspective view of a food shield system with a central beam as disclosed herein.

FIG. 2A is a perspective view of a food shield system with a central beam as disclosed herein.

FIG. 2B is an exploded perspective view of the food shield system of FIG. 2A.

FIG. 3 is a side elevation view of the food shield system of FIG. 2.

FIG. 4 is cross sectional view of a central beam and associated clips.

FIG. 5 is a cross sectional view of a central beam as disclosed herein.

FIG. 6 is a cross sectional view of a right-angle clip.

FIG. 7 is a cross sectional view of an obtuse angle clip.

FIG. 8A is a perspective view of an obtuse angle clip and an associated panel.

FIG. 8B is an exploded perspective view of the obtuse angle clip and panel of FIG. 8A.

FIG. 9A is a perspective view of a right-angle clip and an associated panel.

FIG. 9B is an exploded perspective view of the right-angle clip and panel of FIG. 9A.

FIG. 10 is a perspective and perspective exploded view of an accessory bracket.

FIG. 11A is a perspective view of a support leg.

FIG. 11B is an exploded perspective view of the support leg of FIG. 11A

FIG. 12A is a side elevation view of a support leg connection portion.

FIG. 12B is a perspective view of the support leg connection portion of FIG. 12A.

### DETAILED DESCRIPTION OF THE INVENTION

In the following description, for the purposes of explanation, numerous specific details are set forth in order to provide a thorough understanding of the described embodiments. It will be apparent to one skilled in the art, however, that other embodiments of the present invention may be practiced without some of these specific details. Several embodiments are described herein, and while various features are ascribed to different embodiments, it should be appreciated that the features described with respect to one embodiment may be incorporated with other embodiments as well. By the same token, however, no single feature or features of any described embodiment should be considered essential to every embodiment of the invention, as other embodiments of the invention may omit such features.

Unless otherwise indicated, all numbers used herein to express quantities, dimensions, and so forth used should be understood as being modified in all instances by the term “about.” In this application, the use of the singular includes the plural unless specifically stated otherwise and use of the terms “and” and “or” means “and/or” unless otherwise indicated. Moreover, the use of the term “including,” as well as other forms, such as “includes” and “included,” should be considered non-exclusive. Also, terms such as “element” or “component” encompass both elements and components comprising one unit and elements and components that comprise more than one unit, unless specifically stated otherwise.

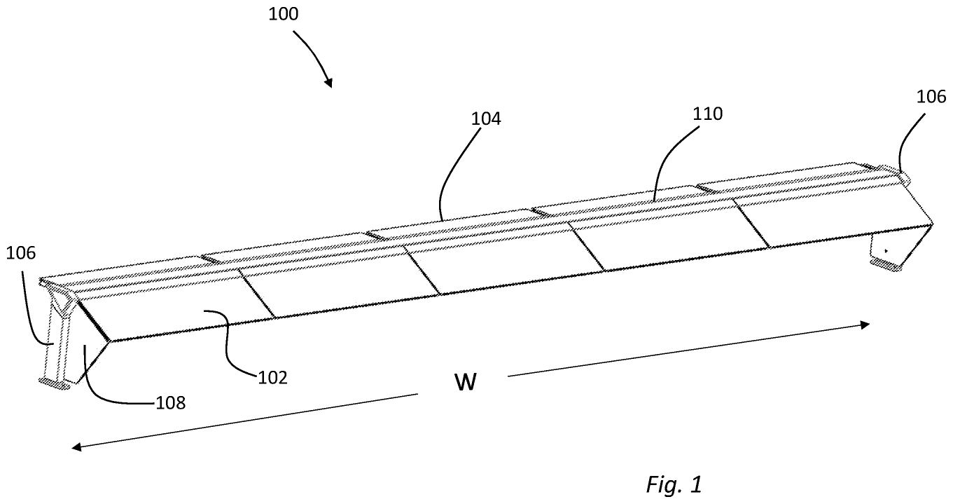

FIG. 1 shows a perspective views of one example of a food shield system 100 featuring an extended length between the legs at the end of the system 100. The system 100 includes customer-facing panels 102 and top panels 104 supported by legs 106. Typically, the food shield system 100 would be mounted over a base (not shown in FIG. 1). The system 100 also includes two end panels 108 attached to the legs 108.

The base positioned underneath the food shield system 100 may be generally configured as a cabinet, table, bar, counter, or the like. The base may include various configurations of trays, receptacles, openings, heating elements, cooling elements, or similar apparatus to permit the attractive and sanitary display of food items or other merchandise. The food shield system 100 may be used in a variety of settings, for example at a buffet, smorgasbord, salad bar, other kind of food display, other retail display, or the like. The food shield system 100 may be as large or complicated as required and can include multiple bases, multiple panels 102, 104, 108 and multiple legs 106 in any configuration. In use, the food shield system 100 protects food or other merchandise from falling debris or other contamination. The panels 102, 104, 108 are typically clear or transparent to enable customers to view displayed food or other products. Representative panels 102, 104, 108 might be fabricated from glass, transparent acrylic, transparent polycarbonate, or similar materials.

The FIG. 1 food shield embodiment 100 spans width W without central support. In other words, the entire food shield system 100 is supported only by legs 106 at each end. The FIG. 1 embodiment spans a greater width W than would be possible if the customer-facing and top panels 102, 104 were implemented as single glass or plastic panels supported only at the ends.

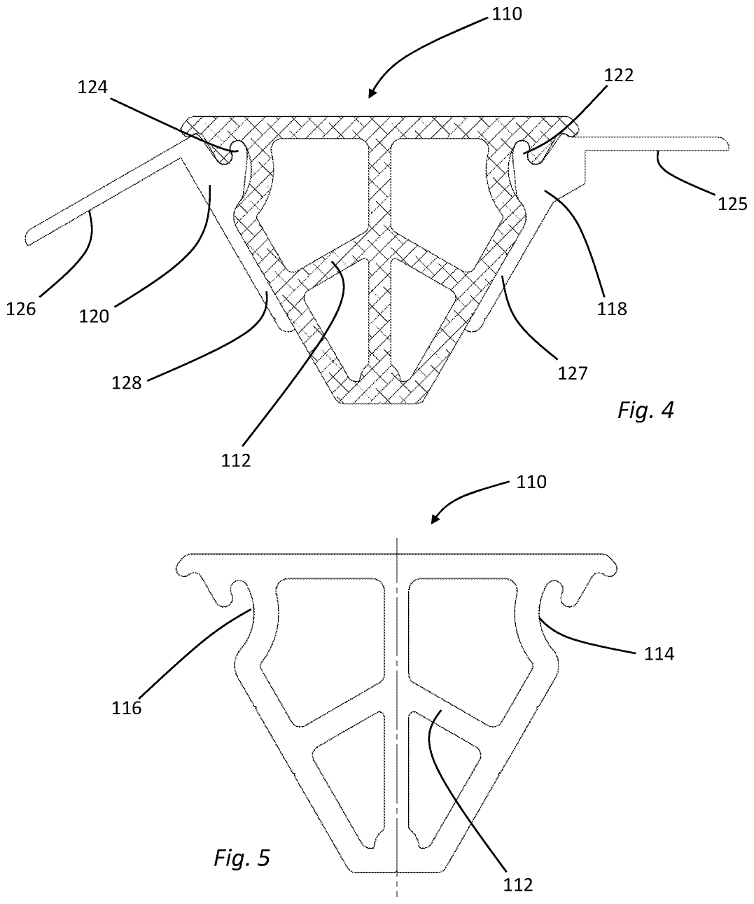

As shown in FIGS. 1-3, the food shield system 100 includes a central beam 110 having the cross-sectional profile shown in FIGS. 4 and 5. The central beam 110 can be an extruded element, for example an aluminum extrusion. Alternatively, the central beam could be machined or built up from subcomponents. Other materials from which the central beam 110 could be fabricated include steel, metal alloys, fiberglass, carbon fiber composite materials and the like.

As shown in FIGS. 4 and 5, the cross-sectional profile of the central beam 110 of the FIG. 1 embodiment is substantially triangular, with the triangle base positioned upward in use. The central beam 110 also includes internal reinforcing elements 112. Although the central beam 110 is not limited herein to any particular cross-section or reinforcement strategy, the illustrated configuration provides substantial rigidity under load, while remaining relatively lightweight.

The central beam 110 includes two opposing hooking surfaces at the top of the beam. The specific hooking surfaces shown in FIGS. 4 and 5 are symmetrical, but for convenience are referred to herein as front hooking surface 114 and rear hooking surface 116. As described in detail below, the front hooking surface 114 and the rear hooking surface 116 are configured to mate with various other elements of the food shield system 100 and attach these elements to the central beam 110. Furthermore, the front and rear hooking surfaces 114, 116 provide for the attached elements to be securely attached to the central beam 110 by the force of gravity.

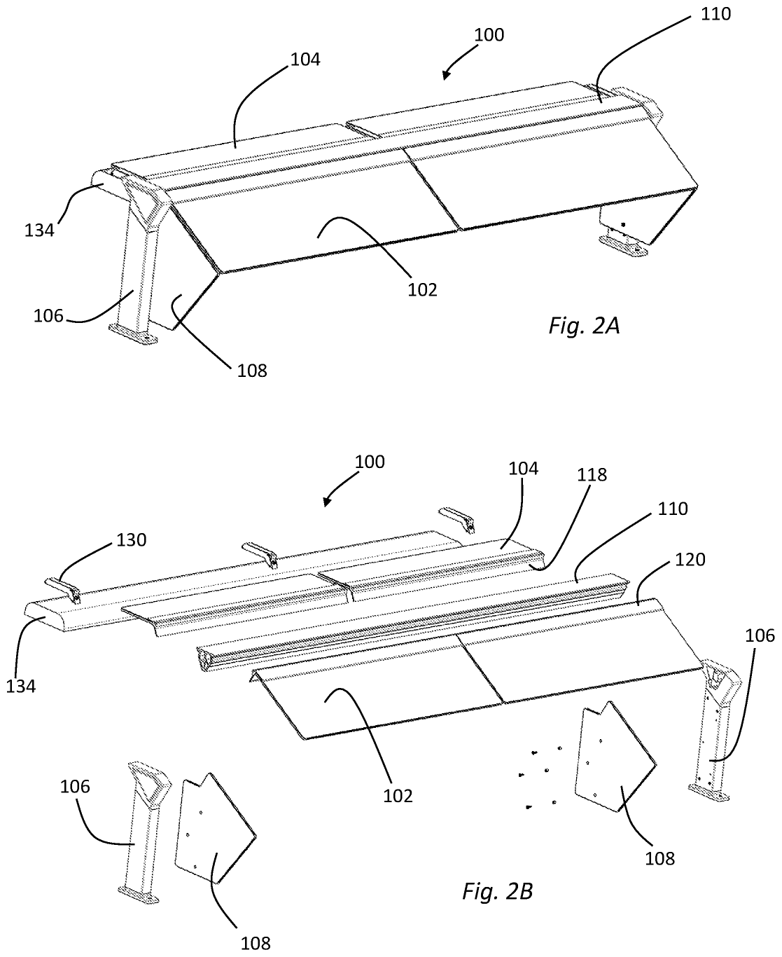

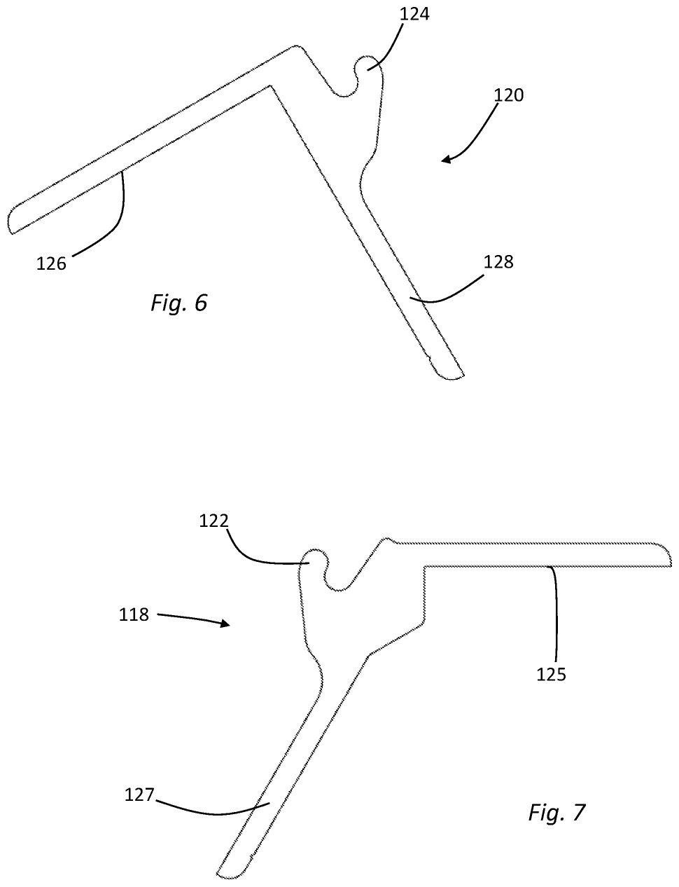

For example, an obtuse angle clip 118 or a right-angle clip 120 may include a hook element (122 and 124 respectively) that can be mated with the front or rear hooking surfaces 114, 116, as shown in FIGS. 2, 4, and 6-9. As shown in the figures, clips 118, 120 are typically relatively long elements that may be extruded or otherwise formed to have the illustrated cross-sections. In the embodiment of FIG. 1-2, each obtuse angle clip 118 may be bonded to a top panel 104 or a portion of a top panel 104 at a bonding surface 125 and each right-angle clip 120 may be bonded to a customer-facing panel 102 or portion of a customer facing panel 102 at a bonding surface 126. The illustrated bonding surfaces 125, 126 are shown on a generally downward facing surface of the respective clip 118, 120. In an alternative embodiment the bonding surfaces 125, 126 may be on the top or upward facing portion of a clip 118, 120.

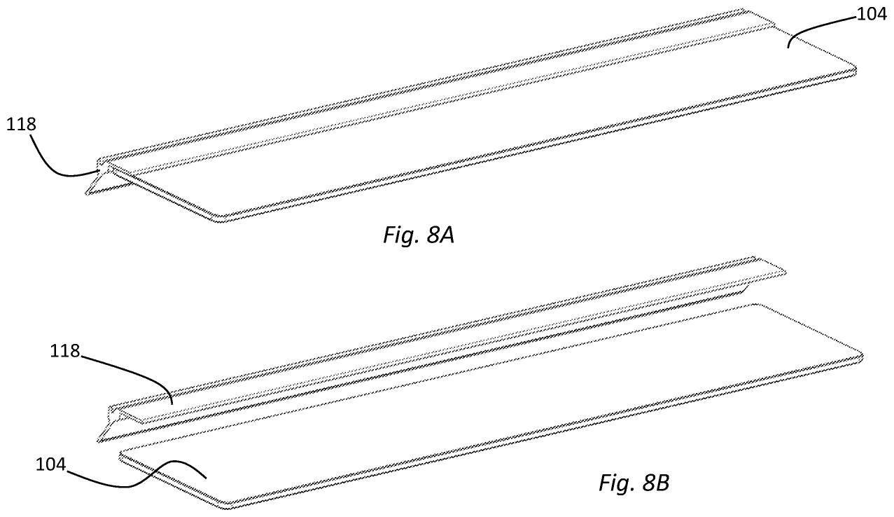

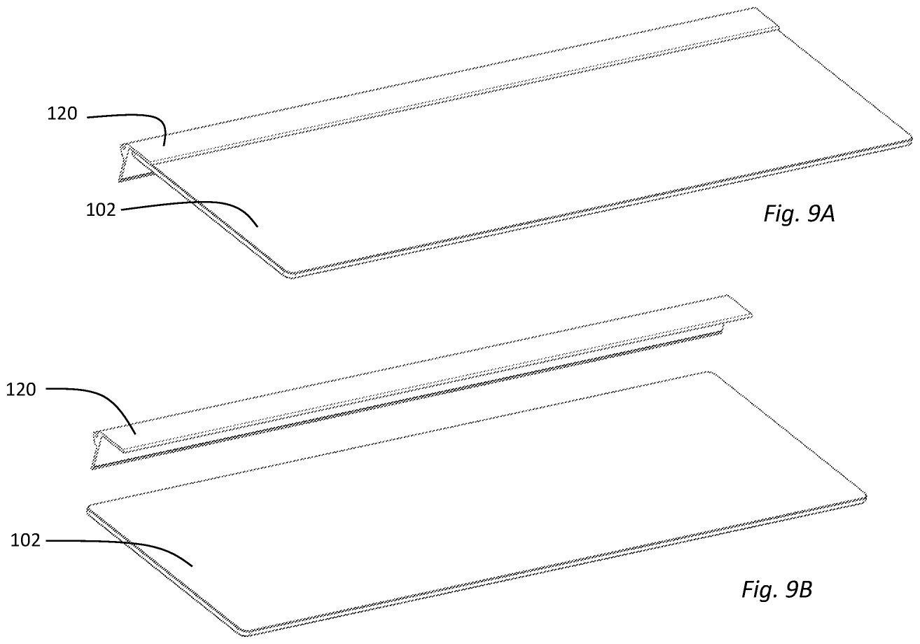

The transparent panels 102, 104 may be bonded to a clip 118, 120 using a UV cured adhesive, other suitable adhesive, mechanical fasteners, or and in some embodiments without the use of mechanical fasteners. A representative top panel 104 bonded to an obtuse angle clip 118 is shown in FIG. 8. A representative customer-facing panel 102 bonded to a right-angle clip 120 is shown in FIG. 9.

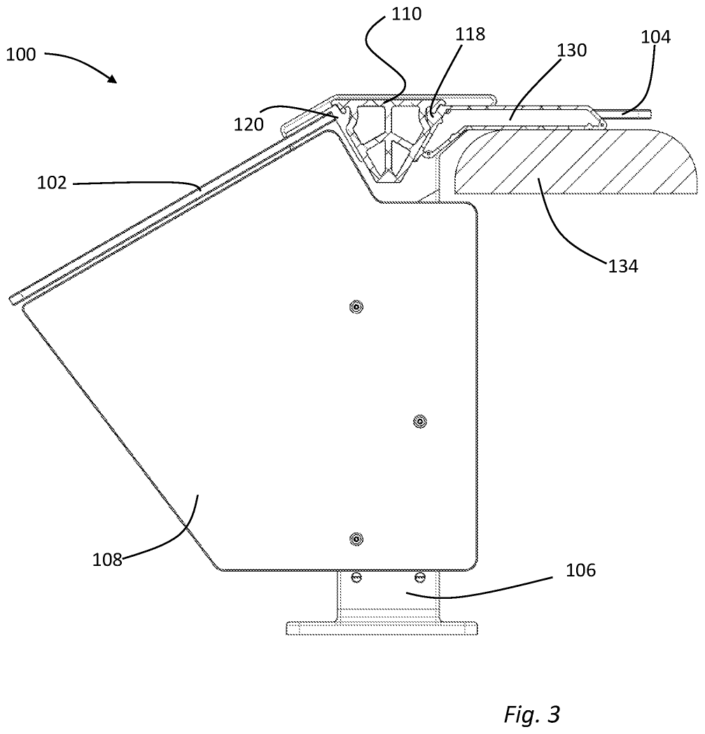

As shown in FIGS. 2 and 3, one or more top panel 104 and obtuse angle clip 118 assemblies and one or more customer-facing panel 102 and right-angle clip 120 assemblies can be hooked to the central beam 110. The illustrated obtuse angle clip 118 includes a lower leg 127 and the illustrated right-angle clip 120 includes a lower leg 128. As best shown in FIG. 4, the lower legs, 127, 128 rest against opposing sidewall surfaces of the substantially triangular central beam 110 in use, and together with the interface of the front and rear hooking surfaces 114, 116 with the hook elements 122, 124 cause the central beam 110 to support each panel and clip assembly.

The planar orientation of any panel 102, 104 is determined by the angle between the bonding surface 125, 126 and the leg 127, 128 of the applicable clip 118, 120 plus the angle of the central beam sidewall where the leg 127, 128 engages same. For example, a right-angle clip 120 engaged with a central beam 110 having a substantially triangular profile causes a customer-facing panel 102 to be held in a plane angled downward from the central beam 110. Similarly, an obtuse angle clip 118 engaged with a triangular central beam 110 causes a top panel 104 to be held in a substantially horizontal plane. Different combinations of clip angles and central beam profiles may be selected to accomplish the support of panels in various selected planes.

Furthermore, each panel and clip assembly is securely locked to the central beam 110 through gravity induced torque alone, but is easily removed by lifting and rotating the associated panel and clip assembly upward. Supplemental screws may optionally be provided to prevent a panel and clip assembly from being inadvertently rotated upward and out of engagement with the central beam 110, however said supplemental screws can be relatively small and unobtrusive since the screws are not load bearing in use.

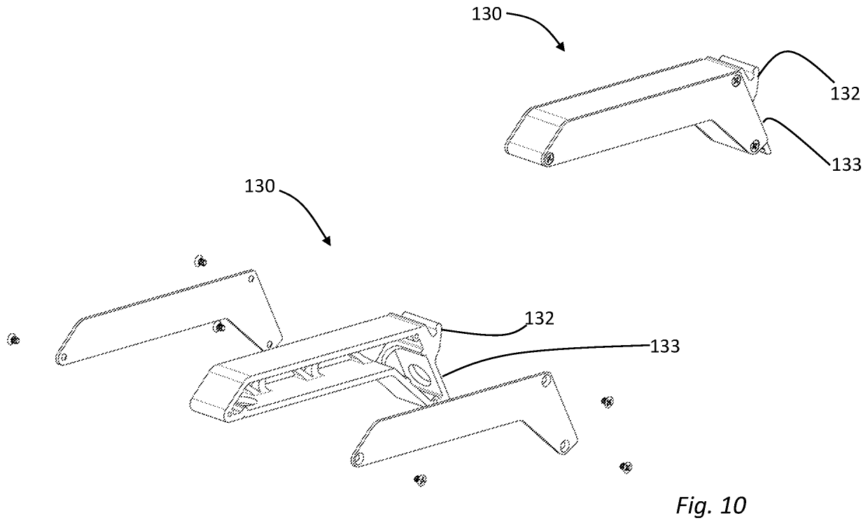

The food shield system 100 may also include one or more accessory brackets 130 to support supplemental equipment. The representative accessory brackets 130 of FIGS. 2, 3, and 10 include a rearward facing hook 132 and a lower leg 133 which in use rests against a side of the central beam 110. Thus, an accessory bracket 130 attaches to the central beam 110 in a manner very similar to the way a clip 118, 120 attaches to the central beam, causing the accessory bracket 130 to be locked into place by gravity induced torque, but easily removed by lifting and rotating the accessory bracket upward.

A representative accessory attached to one or more accessory brackets 130 could, for example, be a heat lamp 134 as shown in FIGS. 2-3. Other accessories of any nature can be mounted to or hung from one or more accessory brackets 130.

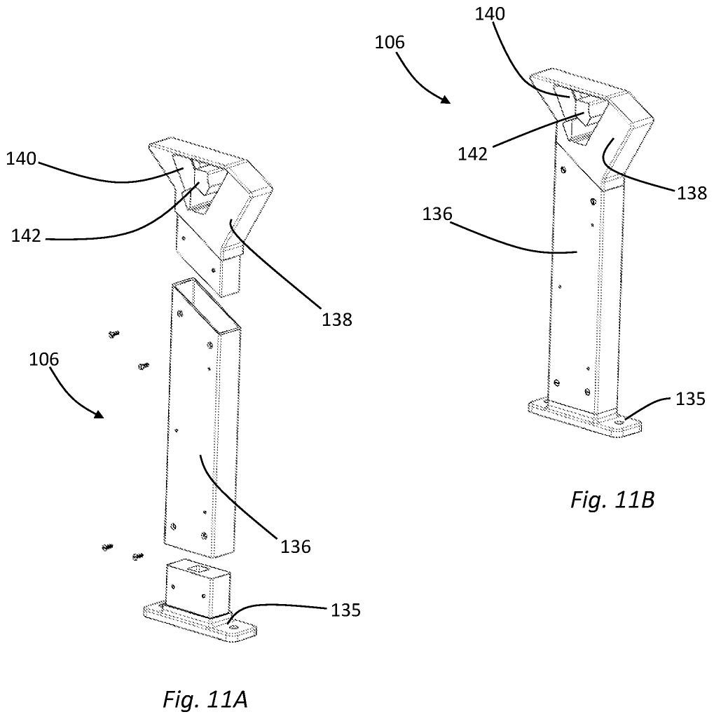

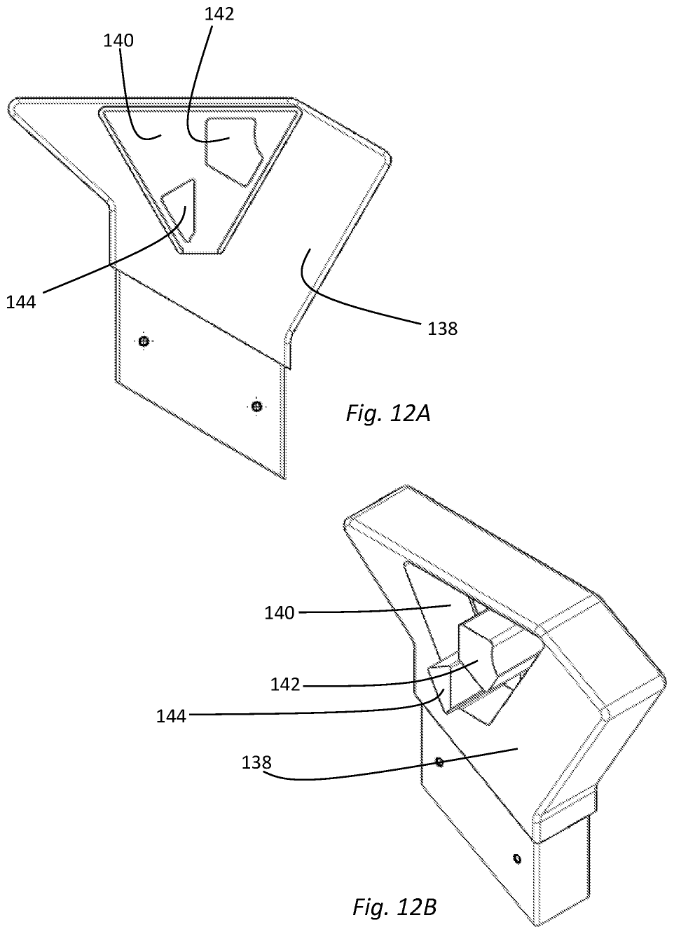

As noted above, the central beam 110 is supported at the ends by a pair of legs 106. As shown in FIG. 11, each leg 106 includes a base 135, a riser column 136 and a top connection 138. The base 135 includes mounting holes or another structure for attachment of a leg 106 to a cabinet, salad bar, or other architectural base. The column element 136 may be fabricated to have any desired height. As best shown in FIG. 12, the top connection 138 includes a socket 140 configured to receive one end of the central beam 110. Optionally, projections 142 and 144 may be formed within the socket 140 to closely couple with corresponding openings in the central beam 110, providing a rigid connection between the central beam 110 and each leg 106.

Having described certain exemplary embodiments, it will be understood by those skilled in the art that many changes in construction and widely differing embodiments and applications of the invention will suggest themselves without departing from the scope of the present invention. Hence, while various embodiments are described with—or without—certain features for ease of description and to illustrate exemplary aspects of those embodiments, the various components and/or features described herein with respect to a particular embodiment can be substituted, added and/or subtracted from among other described embodiments, unless the context dictates otherwise.

What is claimed is:

1. A food shield system comprising:
a central beam comprising at least one hooking surface;
two support legs supporting the central beam at opposing ends of the central beam;
a clip comprising at least one hook element; and
a panel bonded to the clip such that the panel and clip assembly are supported by the central beam when the hook element is engaged with the central beam at the hooking surface.

2. The food shield system of claim 1 wherein the clip comprises a leg extending away from the hook element, which leg rests against the central beam when the hook element of the clip is engaged with the central beam at the hooking surface.

3. The food shield system of claim 1 further comprising:
the central beam comprising a front hooking surface on one side of the central beam;
a front clip comprising at least one front clip hook element;
a customer-facing panel bonded to the front clip at a front clip bonding surface such that the customer-facing panel and front clip are supported by the central beam when the front clip hook element is engaged with the central beam at the front hooking surface;
a rear hooking surface defined on a side of the central beam away from the front hooking surface;
a rear clip comprising at least one rear clip hook element; and
a top panel bonded to the rear clip at a rear clip bonding surface such that the top panel and rear clip are supported by the central beam when the rear clip hook element is engaged with the central beam at the rear hooking surface.

4. The food shield system of claim 3 wherein:
the front clip comprises a front clip leg extending away from the front clip hook element, which front clip leg rests against the central beam when the front clip hook element is engaged with the central beam at the front hooking surface; and
the rear clip comprises a rear clip leg extending away from the rear clip hook element, which rear clip leg rests against the central beam when the rear clip hook element is engaged with the central beam at the rear hooking surface.

5. The food shield system of claim 4 wherein:
the front clip leg defines a right angle with the front clip bonding surface; and
the rear clip leg defines an obtuse angle with the rear clip bonding surface.

6. The food shield system of claim 4 further comprising a plurality of customer-facing panels bonded to separate front clips with each of the plurality of customer-facing panel and front clip assemblies being supported by the central beam between the two support legs.

7. The food shield system of claim 6 further comprising a plurality of top panels bonded to separate rear clips with each of the plurality of top panel and rear clip assemblies being supported by the central beam between the two support legs.

8. The food shield system of claim 3 further comprising an accessory bracket comprising an accessory bracket hook engaged with the rear hooking surface of the central beam.

9. The food shield system of claim 8 wherein the accessory bracket further comprises an accessory bracket leg which accessory bracket leg rests against the central beam when the accessory bracket hook is engaged with the central beam at the rear hooking surface.

10. The food shield system of claim 9 further comprising an accessory mounted to the accessory bracket.

11. The food shield system of claim 1 wherein each of the support legs comprises:
a base;
a riser extending upward from the base; and
a top connection comprising a socket configured to receive one end of the central beam.

12. The food shield system of claim 11 wherein the socket includes one or more protrusions shaped to engage with openings formed in the opposing ends of the central beam.

13. A method of supporting a food shield comprising:
providing a food shield system comprising;
a central beam comprising at least one hooking surface;
two support legs supporting the central beam at opposing ends of the central beam;
a clip comprising at least one hook element; and
a panel bonded to the clip; and
supporting the panel and clip with the central beam by engaging the hook element with the central beam at the hooking surface.

14. The method of claim 13 further comprising:
providing the clip with a leg extending away from the hook element; and
resting the leg against the central beam when the hook element of the clip is engaged with the central beam at the hooking surface.

15. The method of claim 13 further comprising:
providing the central beam with a front hooking surface on one side of the central beam;
providing a front clip comprising at least one front clip hook element;
bonding a customer-facing panel to the front clip at a front clip bonding surface;
supporting the customer-facing panel and front clip assembly with the central beam by engaging the front clip hook element with the central beam at the front hooking surface;
providing a rear hooking surface on a side of the central beam away from the front hooking surface;
providing a rear clip comprising at least one rear clip hook element;
bonding a top panel to the rear clip at a rear clip bonding surface; and
supporting the top panel and the rear clip assembly with the central beam by engaging the rear clip hook element at the rear hooking surface.

16. The method of claim 15 further comprising:
providing the front clip with a front clip leg extending away from the front clip hook element;
resting the front clip leg against the central beam when the front clip hook element is engaged with the central beam at the front hooking surface;
providing the rear clip with a rear clip leg extending away from the rear clip hook element; and
resting the rear clip leg against the central beam when the rear clip hook element is engaged with the central beam at the rear hooking surface.

17. The method of claim 15 further comprising:
providing a plurality of customer-facing panels bonded to separate front clips; and
supporting each of the plurality of customer-facing panel and front clip assemblies with the central beam between the two support legs.

18. The method of claim 15 further comprising:
providing an accessory bracket comprising an accessory bracket hook;
engaging the accessory bracket hook with the rear hooking surface of the central beam; and
mounting an accessory to the accessory bracket.

19. The method of claim 18 further comprising:
providing the accessory bracket with an accessory bracket leg; and
resting the accessory bracket leg against the central beam when the accessory bracket hook is engaged with the central beam at the rear hooking surface.

20. The method of claim 13 further comprising:
providing each of the support legs with;
a base;
a riser extending upward from the base; and
a top connection comprising a socket, wherein said socket includes one or more protrusions; and
supporting the central beam between the support legs by engaging one end of the central beam with each socket such that the one or more protrusions engage with openings formed in the ends of the central beam.
